(19) United States
(12) Patent Application Publication
(10) Pub. No.: US 2012/0327107 A1
(43) Pub. Date: Dec. 27, 2012

(54) FIELD DEVICE HAVING A DISPLAY UNIT AND METHOD FOR OPERATING THE DISPLAY UNIT

(75) Inventors: Nikolai Fink, Aesch (CH); Alain Chomik, Pulversheim (FR); Matthias Brudermann, Moehlin (CH); Elmar Hufschmid, Albbruck (DE); Holger Seguin, Durach (DE); Bert Von Stein, Zell (DE); Matthieu Weibel, Saint Louis (FR)

(73) Assignee: Endress + Hauser Flowtec AG, Reinach (CH)

(21) Appl. No.: 13/511,711

(22) PCT Filed: Oct. 15, 2010
(86) PCT No.: PCT/EP2010/065496

§ 371 Date: Sep. 6, 2012

(30) Foreign Application Priority Data
Nov. 24, 2009 (DE) 10 2009 047 060.3

(51) Int. Cl. G09G 5/00

(52) U.S. Cl. 345/619

(57) ABSTRACT

A method for operating a display unit, which is a component of a field device of process automation technology or is connectable to such a field device, The method includes: invoking a function of a display electronics associated with the display unit by a field device electronics associated with the field device, which function serves for visualizing textual information on the display unit; performing the function by the display electronics, wherein the performing of the function includes receiving textual information from the field device electronics, wherein the textual information is essentially free of composition information relevant to the visualizing of the textual information; and visualizing the transmitted textual information on the display unit based on a display schema stored, especially completely stored, in the display electronics of the display unit, which display schema contains composition information, especially in the form of layouts and/or fonts.

The invention relates to a method for operating a display unit, which display unit is a component of a field device of process automation technology or is connectable to such a field device.

Additionally, the invention relates to a field device of process automation technology having a display unit, which display unit is a component of the field device or is connected or connectable to the field device.

In process and/or automation technology, field devices are often applied, which serve for registering and/or influencing process variables. Examples of such field devices are fill level measuring devices, mass flow measuring devices, pressure and temperature measuring devices, etc., which, as sensors, register the corresponding process variables fill level, flow, pressure or temperature.

These field devices often have an onsite display unit, which serves for visualizing measured values and/or device specific settings, such as, for instance, parameters. Frequently, such an onsite display unit is also combined with a service unit to form a display/service unit.

In order to represent information on the onsite display unit, the onsite display unit is currently often directly controlled by a central electronics unit of the field device. This central electronics unit polarizes the areas required for the representation of the information through corresponding signals, for example, in the case of a liquid crystal display. This requires, however, a specific coordination between the electronics unit and the onsite display unit. Thus, in the case of such a control by the electronics unit, information can only be represented on a specific type of onsite display unit.

For the startup of an automation technology plant, it is required, for example, to know the state of a field device. Furthermore, it is required, for maintenance of a running automation technology plant to obtain a quick overview of the operationally related diagnostic information of the specific field devices of the plant. However, this process relevant information is device dependent to a considerable measure so that such information from different device sources cannot be directly visualized on a display unit, for example, a handheld display unit.

Thus, for example, patent application EP 2012205 A2 describes a method for generating a user interface configuration for at least one field device, in which a user interface description file is generated in a user interface description language from a database, which contains the required device data.

Furthermore, a method for navigating an operating menu of an electronic device having at least one operating element and a display unit has been made known from patent application WO 2005/106632. Especially in the case of change of the hardware of the field devices and/or the display/service units, the software must be correspondingly adapted. Such hardware changes, however, always happen, for example, because of technical progress.

A high maintenance effort is required, when, for example, functional expansions or expansions of the parameters need to be brought about in a field device, since these changes must also then be correspondingly effected in the display unit or the field device electronics and as regards their technical settings.

In the same way, the software in the field devices must be changed when the hardware, especially the display unit, of the field devices changes or is replaced.

An object of the invention, therefore, is to make the representation of process relevant information of a field device as independent of the respectively used display unit as possible.

The object is achieved by a field device and a method for operating the field device.

As regards the method, the object is achieved by method steps as follows:
invoking a function of a display electronics associated with the display unit by a field device electronics associated with the field device, which function serves for visualizing textual information on the display unit,
performing the function by the display electronics,
   wherein performing the function includes receiving textual information from the field device electronics, wherein the textual information is essentially free of composition information relevant to the visualizing of the textual information;
   wherein performing the function includes, furthermore, visualizing the received textual information on the display unit based on a display schema stored, especially completely stored, in the display electronics of the display unit, wherein the display schema contains composition information, especially in the form of layouts and/or fonts.

It is thus an idea of the invention to separate the content of information from its representation. As regards hardware, this can be achieved through a separation into at least two electronic units, on the one hand, the field device electronics and, on the other hand, the display electronics. While the field device electronics, for example, primarily serves for producing and/or processing the process relevant information, the display electronics serves essentially for visualizing the textual information produced, for example, by the field device electronics. In such case, process relevant information is understood to be, for example, measured values as well as parameter values or status values, for example, of the field device. This textual information can then be visualized, i.e. graphically represented, by the display electronics, especially on a screen associated with the display unit. For such purpose, at least one display schema as well as other composition information can be stored in the display electronics. Since the display schemas can be different depending on the type of display unit, the method, for operating the display unit, provides that the field device electronics invokes a function of the display electronics, which at least serves for visualizing the textual information on the display unit. The display unit can be an onsite display unit or the display unit of a so called handheld or the display unit of a remote control room. The invoked function can utilize different display schemas, for example, tables, lists, display menus and the like for visualizing, depending on the type of display unit.

Other textual information required by the display electronics for performing the function can then be requested by the display electronics. Due to the different size, for example, of the screens of two different display units, consequently, for example, a different number of values can be displayed on a page illustrated on a screen. On a display unit having a smaller screen compared to another display unit, for example, a scroll bar or the use of a smaller font can be required for selection. However, the situation can also arise that only specifically selected information can be displayed on a display unit having a smaller screen. It is, consequently, advantageous to adapt the function of a display unit to the technical conditions of the display unit, for example, by storing the function in the display unit and/or adapting it specially to the applied display unit.

After this function is invoked and the textual information is transmitted to the display unit, and, respectively, is received by the display unit, the textual information, especially adapted to the specific embodiment of the display unit, can be visualized on the display unit. The visualization is dependent, in such case, for example, on the composition information such as e.g. layouts in the form of, for example, tables, lists etc., and/or fonts stored in the display electronics. Likewise the visualization can be dependent on the hardware of the display unit used. A relevant factor is, for example, the color representation of the display unit used. The representation, especially the color representation, can, for example, be in color or monochromatic.

This offers the advantage that, in the case of process relevant information for a number of different field devices, i.e. field devices having different display units, which have different display capacities, the, in each case, available display capacity is regularly utilized, at least approximately, optimally. The display capacity can be, for example, the number of pixels available to a display unit or its display element. More generally, the information or the amount of data, which can be simultaneously represented on the display, can be considered as the display capacity. A single display unit can suffice for a large number of different kinds of field devices/field device electronics. On the other hand, different display units can be connected to one field device or one application. Through the high numbers of universal field devices and, respectively, display units, manufacturing costs can be significantly reduced. Furthermore, the use of new interaction concepts, such as e.g. a touch screen, etc., becomes possible without having to adapt the field device software.

A page shown on the display unit can essentially be produced by means of textual information produced by the field device electronics. The required composition information is stored, for example, in a memory unit of the display electronics. The actual appearance of a page as well as that of each individual letter is thus stored in the display electronics, for example, in the form of a display schema, font and/or character set. This representation specific information is missing when the textual information should be processed on another computer, which does not have a corresponding application for processing the textual information. Even the slightest differences in letter form or letter spacings add up within a row so rapidly that suddenly the last word no longer fits into the desired row. In this way, the entire additional text shifts and the composition becomes completely jumbled.

Since essentially only the pure textual information and no additional information relevant to visualization is transmitted, the amount of data to be transferred to the display unit can be reduced. The textual information can be present and/or transmitted, for example, in the form of data.

In an embodiment of the method, the display electronics, especially after the call up of the function by the field device electronics, requests, especially from the field device electronics, the textual information required for the performance of the function. After the call up of a function in the display electronics, the contents for performing the function, for example, for producing a page on the screen of the display unit are still required, with which contents this page should be filled. The amount of information, which can be presented on a page of the screen of the display unit, can vary, however. Therefore, only the contents actually required for the representation of the page are called up by the display electronics of the field device electronics. In this way, the amount of data to be transferred can be reduced further.

Another embodiment of the method includes steps of servicing the field device via a service unit associated with the display unit, and of transmitting to the field device electronics a return value of the invoked function triggered by the servicing, especially when ending the invoked function. As mentioned above, the display unit can have a display electronics, a screen and a service unit. Such a display/service unit can be used as an HMI, thus as a human machine interface, in order to process the inputs of a user. Through the inputs, for example, settings of the field device can be made and its operation can be controlled.

All information concerning the visualizing and/or editing of the textual information on the display unit are actually present only in a display electronics dedicated to the display unit or at least associated with the display unit. For such purpose, for example, a memory unit can be provided in the display unit, in which this composition information is stored or will be stored. The field device electronics, consequently, must no longer have the exact size of the display unit, its color representation, etc. Rather, the field device electronics requests the display unit to visualize process relevant information according to a representation stored in the display unit. This representation naturally varies as a function of the display unit available. In order to obtain a unified representation even on different display units, the same font can be present, for example, in different sizes. Certain settings of a layout such as, for example, background color etc., however, can be transmitted, for example, as control words in text form to the display unit. These control words can be inserted into the textual information before it is sent to the display unit. A control word can be converted, for example, into a non-printable, special character.

The layout information of the display unit can be integrated into a page and visualized on the display unit. The page can present, for example, a selection of control commands, which can be selected by means of the service unit. Consequently, functions, which serve as a text editor, a simple selection list, etc., can be invoked and their contents can be presented on a page. The invoking and performing of a function can then be understood as the creation of a page. The page can be, for example, the main measured value page. The page can require, for example, input parameters for initializing. The display electronics then requests the residual data, in the form of textual information, for filling out the page. In such case, the individual entries of a page, in each case, can be queried separately. In such case, the amount of data to be transferred can vary, depending on the page.

In an additional embodiment of the method, the transmitted textual information is changed by the servicing, and the edited textual information, for example, is requested by the field device electronics after the transferring of the return value or transmitted to the field device electronics after the transferring of the return value.

In a form of embodiment of the method, the interpretation of the return value or the edited textual information, especially the associating of the return value or edited textual information to a desired adjustment of the field device, is performed in the field device electronics.

In the case of inputs via the service unit, the inputs undertaken by the operating elements can be mapped to the currently visualized page. The data edited by the inputs are then sent to the field device electronics, where the edited textual information can be evaluated. Additionally, or alternatively, a return value such as e.g. “OK” or “cancel” etc., can be transmitted to the field device electronics, which return value is determined by the operating of the service unit. The operating/servicing elements can be so called softkeys or hardware keys. The meaning associated with the actuation of one of these operating elements can be fixed by the field device electronics especially as a function of the page currently visualized on the display unit or the invoked function.

In a form of embodiment of the method, the step of invoking the function of the display unit includes the step of transmitting data from the field device electronics to the display electronics.

In an additional form of embodiment of the method, the step of receiving textual information from the field device electronics by the display electronics likewise includes the step of receiving the data from the field device electronics by the display unit. For this purpose, this data can be transmitted from the field device electronics to the display electronics.

In a variant of the method, the step of transmitting a return value to the field device electronics likewise includes the step of transmitting data from the display electronics to the field device electronics.

In an additional variant of the method, the data are transmitted using a first protocol. The data can, of course, be encoded for this.

In an additional variant of the method, the field device electronics includes a first display server, by means of which first display server the data are transmitted, especially using the first protocol, to the display unit. The data can be transmitted, especially by means of the first protocol, to the display electronics. The display server can be embodied, for example, by a computer unit of the field device electronics and produce the textual information, which is transmitted to the display unit.

In a further development of the method, the display electronics includes a display client, wherein, by means of the display client the transmitted data are interpreted and visualized on the display unit. The display client can, thus, produce a page, which is visualized on the display unit. The display server and/or the display client can be programs, by means of which the data exchange between the field device electronics and the display unit is controlled.

In an additional further development, a layout is fixed by the invoked function, and the textual information is visualized on the display unit in a font available in the display unit. A layout, for example, can be abstract elements having defined properties, such as, for example, a table. However, the layout initially has no content.

In a implementation of the method, when the display unit is connected to the field device, the data are exchanged via a communication interface, especially a USE interface, of the field device. Through modularizing of the functionalities of the field device, which modularizing arises from the isolation between the field device electronics and the display electronics, different display units can be used for visualizing process relevant information of a field device. Especially thereby, the visualizing is enabled on a so called handheld and/or in a remote control room. However, through modularizing, a communication between the participants of the so arising network is necessary, here by means of the display server and the display client.

In an additional implementation of the method when the display unit is connected to the field device, and the display client communicates with the field device via the communication interface using a second protocol, the first protocol is tunneled via the second protocol. For such purpose, it is advantageous to use the previously mentioned USB interface and, correspondingly, the USE protocol due to its distribution and universality. In this way, the field device can be connected, for example, to a PC. The driver for a USE device is usually integrated in such a PC system. A network of display servers can be formed, which exchange the textual information of various electronic units of a field device electronics, such as, for example, sensor electronics, main electronics, I/O unit etc., of a field device with a display client of a display unit.

In an additional implementation of the method when the display unit is connected to the field device, the display client is loaded from the field device into the display unit, especially the display electronics, by means of a third protocol. In case the display unit is connected to the field device, and does not have the needed display client, this display client can be stored on a memory unit in the field device. The display client can then be transmitted to the display unit. Subsequently, the display client can, for example, be started on the display unit and the textual information produced in the field device electronics can be displayed. The third protocol can likewise be the USB protocol. A program, especially the display client, can be stored in the field device; the program is accessible via the USB interface. Alternatively, an auto start function can show the user a dialog, which permits the user to start the program on the field device directly from the memory. The program provides a menu on the display/service unit for the user, via which menu the user can, among other things, perform a configuration of the field device. In this regard, for example, an additional connection between the field device and the display unit is produced by means of the program and especially via the USB interface. The textual information can then be transmitted via this connection. Due to the isolation between visualization and content, the program can be used for different field devices, wherein the servicing of each field device occurs individually. As a result, no specific information on the particular field device, for example, in the form of a device description or a device type manager, is required in order to perform a configuration, for example, by means of a PC.

In an additional implementation of the method, the field device includes a sensor electronics in addition to the field device electronics; the sensor electronics has a second display server, via which second display server textual information, in the form of data, is likewise exchanged between the sensor electronics and the display electronics by means of the first protocol. The sensor electronics can indeed be connected to the field device electronics and/or the display electronics for communication purposes, however, is spatially isolated from the field device electronics and/or the display electronics in one embodiment. The sensor electronics of a field device mainly serves for recording the so called primary measurement, in that it, for example, produces raw measured data or raw measured values. These raw values/raw measured data can then be transmitted to the field device electronics. In the field device electronics, the so called secondary measurements can then be derived from the raw measured data/raw values in addition to the primary measurement. The display server of the sensor electronics can likewise create its own pages on the display unit. The main electronics can also independently create pages on the display unit, by means of which the configuration of the main electronics is represented or the configuration of the main electronics is changed. In this way, for example, different sensors, including sensor electronics, can be connected to a field device electronics, without, in such case, having to set up new software and the like on the field device, i.e. without the main electronics having to know and manage their operation. The sensor electronics uses its own display server in order to represent and/or conduct its own parametering.

In an additional implementation of the method, the sensor electronics and/or the field device electronics are/is configured with the display electronics by exchange of the edited textual information. For such purpose, the edited textual information is read back into the sensor electronics or into the field device electronics and the settings made therein are assumed.

As regards the field device, the object is achieved by features including that the field device has a field device electronics, which serves to invoke a function of the display unit, which function serves for visualizing textual information on the display unit, which field device electronics furthermore serves to transmit textual information required for performing the function, especially in the form of data, to the display unit, that the display unit has a display electronics, which serves for performing the invoked function, that the display electronics furthermore serves to visualize the transmitted textual information based on a display schema stored in the display electronics; the display schema contains composition information, especially in the form of layouts or fonts.

The invention will now be explained in greater detail based on the appended drawing, the figures of which show as follows:

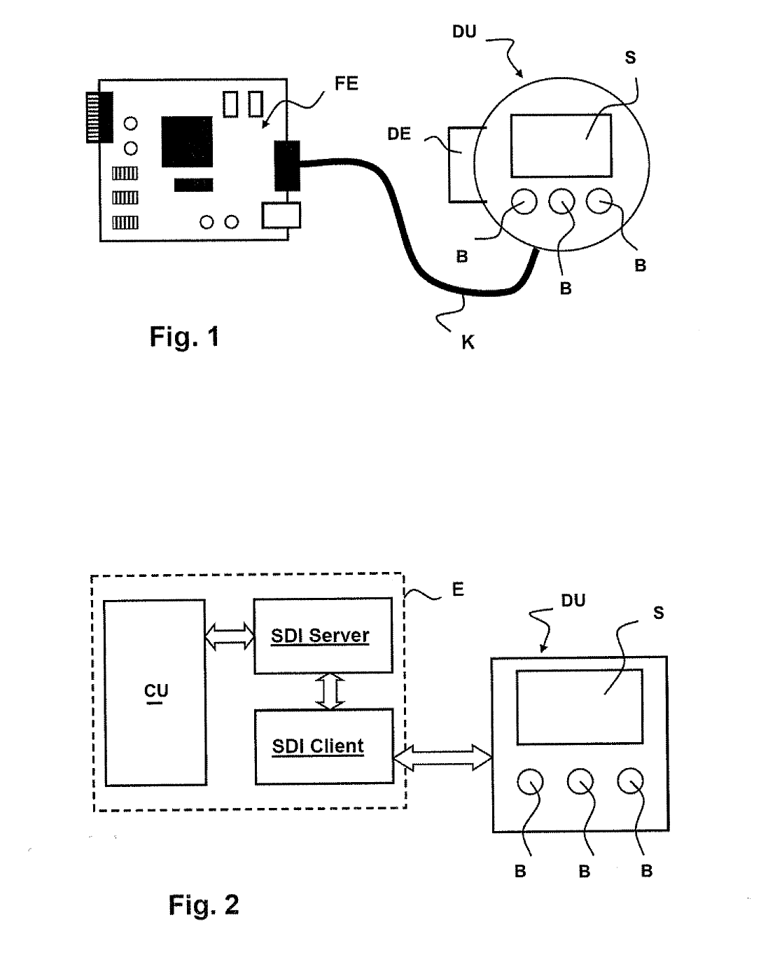

FIG. 1 a schematic representation of a field device electronics as well as a display unit having a display electronics, a screen and operating elements;

FIG. 2 a representation of a field device electronics and a display unit having a display electronics, wherein the display client is executed in the same computer unit as the display server;

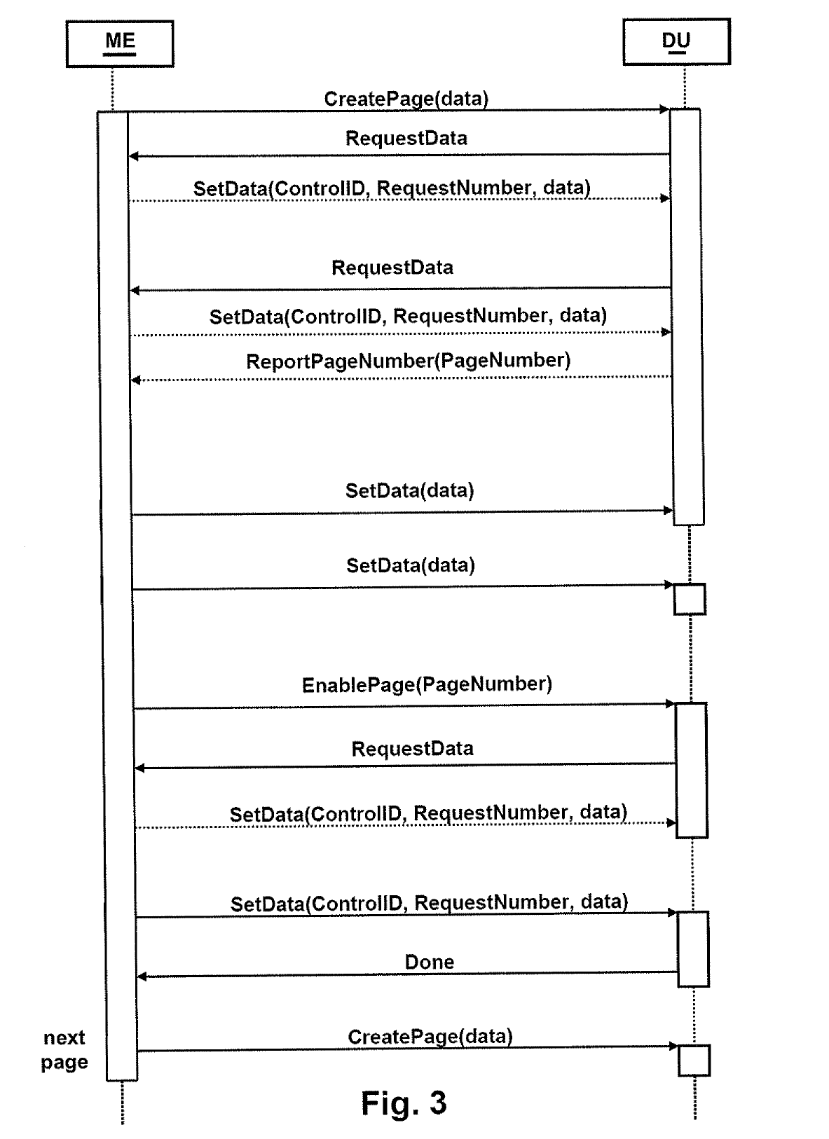

FIG. 3 a flow diagram of a data exchange between a field device electronics and a display unit for visualizing a page on a screen of the display unit;

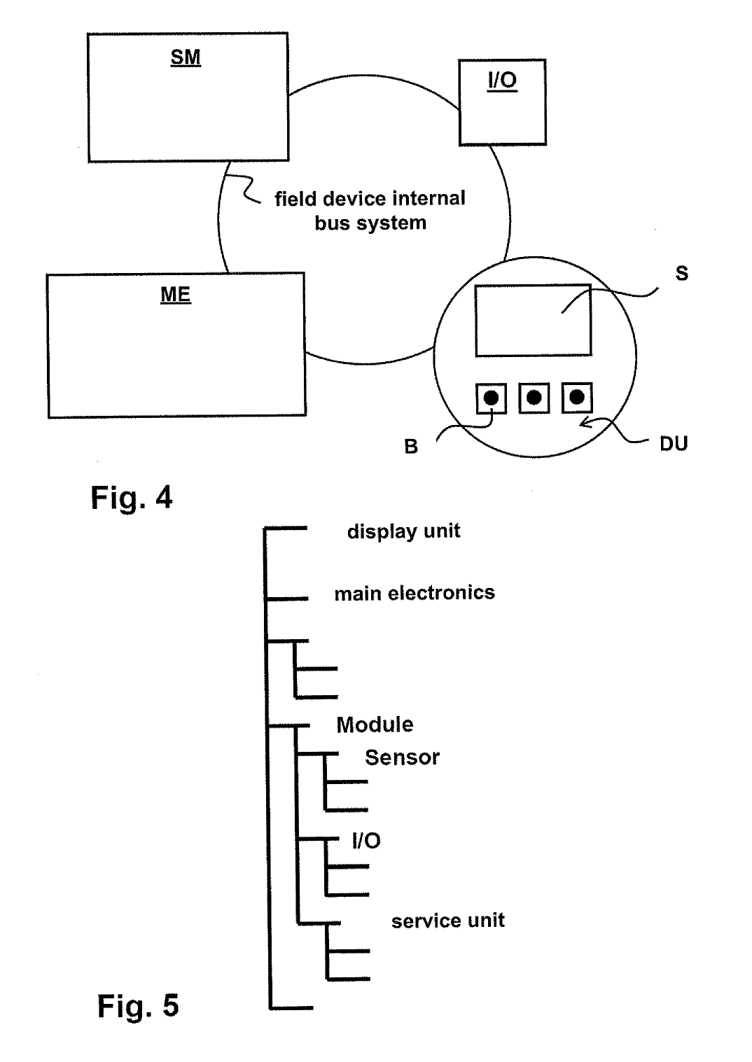

FIG. 4 a schematic representation of an internal bus system of a field device; and

FIG. 5 a schematic representation of the structure of the internal bus system of the field device.

FIG. 1 shows a display unit DU as well as a field device electronics FE, which are connected to one another via a cable K.

Display unit A includes a screen B and three operating elements T. Screen S can be a liquid crystal display. Operating elements B can be buttons, or keyboard keys, for example.

Via cable K, which is connected to a communication interface I/O of field device electronics FE, display unit DU is connected to field device electronics FE. Instead of the cable, however, another type of connection can be provided between the field device electronics and the display unit.

A display server, SDI server, is executed, in such case, by the field device electronics FE and can operate a number of display units DU having different hardware characteristics. In this regard, textual information is made available by the display server, SDI server. The display server, SDI server, transmits this textual information to a display client SDI client, which is executed by the display electronics DE and contains the composition information required for visualizing the textual information sent. Representation, or composition, information is understood to be, for example, fonts, icons and bitmaps, etc., which serve for visualizing the textual information. The textual information can be, for example, measured values, parameter values, configuration values, etc.

FIG. 2 shows an additional form of embodiment of a field device having an electronics unit E and screen S. In this case, display client SDI client and display server, SDI server, are executed by one or more components of electronics unit E. The components of electronics unit E are arranged, for example, on a circuit board or at least in a related section of the field device, which contains the electronics. Control unit CU can involve, for example, additional functionalities of the field device, which, for example, are likewise executed as software by the electronics unit. Among these functionalities are, e.g., ascertainment of the measured value or calculation of secondary variables, for example, from the primary measured value recorded by means of a sensor. It is possible to execute the display server and the display client on one or more different electrical and/or electronic components. Thus, for example, the display server can be executed or stored by a first computer and/or memory unit and the display client can be executed or stored by a second computer and/or memory unit. The first and/or second computer unit can be a microprocessor or microcontroller. These electrical and/or electronic components can be arranged, for example, within a field device. The components of the electronics unit, which serve for the embodiment of the display clients, can nevertheless be considered for display unit DU, which includes screen S and the second computer and/or memory unit. The display client is also connected to screen S, wherein screen S is operated in the conventional manner via this connection, while the textual information is exchanged between the display server and the display client.

A specific number of pages are defined in order to bring process relevant information for display on display unit DU or the associated screen S. In each case, only one page can be presented on screen S of display unit DU. A page can include, among other things, a certain number of variable values, which can, for example, be edited. The variable values can be, for example, the periodically updated measured values of a sensor.

FIG. 3 shows a flow diagram for the creation of a page on screen S of display unit DU. The pages can have different functionalities. The pages can be distinguished from one another, for example, by a certain identification. When a page is initialized, it obtains a unique number (“PageNumber”). This number is sent to field device electronics FE. By means of this number, this page can be referenced by field device electronics FE. In the case of sending, for example, a new “CreatePage” command via field device electronics FE (“Main Electronic”), the existing page is dropped by display unit DU (“Display”).

A page, in such case, can encompass all of screen S of display unit DU or only a part of screen S. Display unit DU is thus requested to present a certain page by field device electronics FE. Display unit DU requests, in turn, the data from field device electronics FE by means of the “RequestData” command. In order to present the page on screen S, the page must be enabled. This happens by means of the “EnablePage” command. Thereafter the page can be edited by means of the operating elements. The edited textual information is then transmitted back to the field device electronics in the form of data. The editing can be ended, for example, by the operating personnel by means of the “done” command. As a result, a new page can be invoked by the field device electronics and be presented on the display unit.

For listing parameters, for example, a page includes a cell, which can reflect five elements on a larger screen S, while the cell can only reflect three elements on a smaller screen S.

After all data required for initializing the page has been queried (“RequestData”, “SetData”), display unit DU sends the command “ReportPageNumber” to field device electronics FE. Field device electronics FE can then transmit additional data to display unit DU.

A change of the settings by means of the display unit can then be made as follows:

1) The field device electronics FE calls up a page on screen S, for example, by means of the command “start menu”.
2) Screen S shows the menu.
3) A user sees and/or changes the indicated parameter settings.
4) The user selects an option, for example, “OK”, and the settings are stored.
5) Display unit DU sends the return value “page ready” to field device electronics FE
6) Field device electronics FE reads the settings contained in the returned textual information, perhaps edited textual information, and correspondingly updates its settings.
7) Field device electronics FE calls up a new page.

FIG. 4 shows the electronics modules of a field device connected with one another via an internal bus system of the field device. The participants of this internal bus system of the field device are modules, such as, for example, the main electronics ME of the field device, display unit DU, the communication interface I/O as well as a sensor module SM. Each of these modules can have a dedicated electronics and its own display server, SDI server, which enables it to represent information on the screen of display unit DU using the proposed method.

FIG. 5 shows the hierarchical structure of the field device modules connected to the internal bus system of the field device. As shown in FIG. 4, the modules are the main electronics, sensor, communication interface I/O on the fieldbus for example, as well as display/service unit, which are connected to one another by the internal bus system of the fieldbus. Each of sensor SM, communication interface I/O as well as main electronics ME has its own display server, SDI server, by means of which information can be represented on screen S of display/service unit DU via a display client SDI client in display/service unit DU. It is also possible that the service unit is isolated from display unit DU, and likewise has a display client SDI client, by means of which the service unit shows, for example, its configuration on screen S of display unit DU.

### LIST OF REFERENCE CHARACTERS

DU display unit
DE display electronics
S screen
B operating element
K cable
electronics unit
CU control unit
FB fieldbus
ME main electronics
I/O communication interface
SDI server display server
SDI client display client
SM sensor

1-15. (canceled)

16. A method for operating a display unit, which display unit is a component of a field device of process automation technology or is connectable to such a field device, comprising the steps of:
invoking a function of a display electronics associated with the display unit by a field device electronics associated with the field device, which function serves for visualizing textual information on the display unit; and
performing the function by the display electronics, wherein:
performing the function includes receiving textual information from the field device electronics;
the textual information is essentially free of composition information relevant to the visualizing of the textual information;
performing the function includes, furthermore, visualizing the received textual information on the display unit based on a display schema stored, especially completely stored, in the display electronics of the display unit; and
the display schema contains composition information, especially in the form of layouts and/or fonts.

17. The method as claimed in claim 16, wherein:
the display electronics, especially after invoking the function by the field device electronics, queries, especially from the field device electronics, textual information required for performing the function.

18. The method as claimed in claim 16, further comprising the steps of:
servicing the field device via a service unit associated with the display unit; and
transmitting to the field device electronics a return value of the invoked function triggered by the servicing, especially when ending the invoked function.

19. The method as claimed in claim 18, wherein:
the transmitted textual information is edited by the servicing, and the edited textual information is requested after the transfer of the return value from the field device electronics or is transmitted to the field device electronics after the transfer of the return value.

20. The method as claimed in claim 18, wherein:
interpretation of the return value or the edited textual information, especially an associating with a desired adjustment of the field device, is performed in the field device electronics.

21. The method as claimed in claim 16, wherein:
the step of invoking the function of the display unit includes the step of transmitting data from the field device electronics to the display electronics; and/or
the step of receiving the textual information likewise includes the step of receiving data from the field device electronics by the display electronics, and/or
the step of transmitting a return value to the field device electronics likewise includes the step of transmitting data from the display electronics to the field device electronics.

22. The method as claimed in claim 21, wherein:
the data are transmitted via a first protocol.

23. The method as claimed in claim 16, wherein:
the field device electronics has a first display server, by means of which first display server the data are transmitted to the display unit, especially via the first protocol.

24. The method as claimed in claim 23, wherein:
the display electronics has a display client; and
by means of the display client the transmitted data are interpreted and visualized on the display unit.

25. The method as claimed in claim 24, wherein:
a layout is fixed by the invoked function; and
the textual information is presented on the display unit in a font available in the display unit.

26. The method as claimed in claim 16, wherein:
when the display unit is connected to the field device, the data are exchanged via a communication interface, especially an interface of the field device.

27. The method as claimed in claim 25, wherein:
when the display unit is connected to the field device, the display client communicates with the field device via the communication interface using a second protocol; and
the first protocol is tunneled via the second protocol.

28. The method as claimed in claim 27, wherein:
when the display unit is connected to the field device, the display client is loaded from the field device into the display unit, especially the display electronics, by means of a third protocol.

29. The method as claimed in claim 28, wherein:
the field device has sensor electronics in addition to the field device electronics, which sensor electronics has a second display server, via which second display server textual information is likewise exchanged in the form of data between the sensor electronics and the display electronics by means of the first protocol.

30. A field device of process automation technology having:
a display unit, which is a component of the field device or is connected to the field device or is connectable to the field device; and
field device electronics, which serves to invoke a function of the display unit, which function serves for visualizing textual information on the display unit, which field device electronics furthermore serves to transmit the textual information, especially in the form of data, required for performing the function to the display unit, wherein:
said display unit has display electronics, which serves for the performing of the invoked function; and
said display electronics furthermore serves to visualize the transmitted textual information based on a display schema stored in said display electronics, which display schema contains composition information, especially in the form of layouts or fonts.
